(19) United States
(12) Patent Application Publication
(10) Pub. No.: US 2020/0290326 A1
(43) Pub. Date: Sep. 17, 2020

(54) POLYMER FILMS

(71) Applicant: Johnson Matthey Public Limited Company, London (GB)

(72) Inventors: Alexey GOIHMAN, Western Galilee (IL); Asaf SHACHNAI, Western Galilee (IL); Gary WARD, Western Galilee (IL)

(21) Appl. No.: 16/753,032

(22) PCT Filed: Oct. 5, 2018
(86) PCT No.: PCT/GB2018/052841

§ 371 Date: Apr. 2, 2020

(30) Foreign Application Priority Data
Oct. 6, 2017 (GB) 1716345.2

(51) Int. Cl. B32B 27/08; B32B 27/34; B32B 27/36; B32B 27/32; B32B 27/30; B32B 27/18; B65D 65/40

(52) U.S. Cl. CPC B32B 27/08; B32B 27/34; B32B 27/36; B32B 27/32; B32B 27/302; B32B 2307/704; B32B 27/18; B65D 65/40; B32B 2439/70; B32B 2307/724; B32B 27/306

(57) ABSTRACT

Packaging films suitable for packaging fresh produce comprising a first layer of polymer film which comprises an amorphous copolyamide or a polyamide blend comprising at least one amorphous polyamide. The packaging films have a water vapour transmission rate of between 15 and 150 g/m2 at 23° C. and 50% relative humidity. The films have enhanced visual properties and may be advantageous used for the retail packaging of fresh produce.

### FIELD OF THE INVENTION

The present invention relates to the packaging of fresh produce, in particular to packaging films suitable for packaging fresh produce. The invention has particular application in the retail packaging of fresh produce.

### BACKGROUND TO THE INVENTION

Fresh produce items, such as fruit and vegetables, may be packaged at source directly into retail packaging, which is the form of packaging in which the produce is displayed in retail stores. As an alternative, fresh produce may be packaged at source into bulk packaging for transportation, and then repackaged into retail packaging after arrival at a packing facility close to the point of sale. There are a number of advantages associated with packing at source into retail packaging, for example a reduction in handling costs and avoiding double handling.

Retail packaging for fresh produce should enhance the appearance of the produce and should be appealing to the consumer. Various polyolefin films are commonly used for retail packaging due to their visual properties, such as high clarity and nice feel. Examples include cast polypropylene (CPP), bioriented polypropylene (BOPP) and certain grades of polyethylene (PE). These films typically also have the benefit of straightforward processing on automated packing lines.

Nevertheless, these films have certain drawbacks. Polyolefins are characterized by low water vapour transmission rates (WVTR). Water vapour that is given off by the produce during respiration will raise the headspace relative humidity in any fresh produce packaging. The very low water vapour transmission rates of polyolefins means that at steady state, the headspace relative humidity within such packaging will be close to saturation. Such high humidity will aggravate microbial decay of fresh produce as well as certain physiological disorders such as regrowth of shoots and sprouting of root vegetables. In order to alleviate this, the packaging may be macro-perforated, however this will increase dehydration and also means relinquishing any potential benefits associated with modified atmosphere being generated in the packaging.

So although there are some produce items and supply chains for which polyolefin based retail packaging with modified atmosphere can be used and provide benefit, there are others in which the risks may often outweigh the potential. Examples include avocado, green beans, berries, cucumbers, mango, mushrooms, papaya, passion fruit, pomegranates and squash.

As described in U.S. Pat. No. 6,190,710, polyamide films such as nylon-6 or nylon-66 provide a suitable WVTR for many fresh produce items. In addition, U.S. Pat. No. 6,190,710 describes how polyamide films used in packaging can be perforated to provide control of oxygen and carbon dioxide diffusion between the atmosphere inside the package and the surrounding environment. Typically, polyamide films provide a significantly higher WVTR than polyolefin films. However, such films are not widely used in retail packaging due to poor visual properties, the challenge of using such films for automated packaging processes, and problems with dehydration of certain produce types.

WO2017/046595 (Johnson Matthey Public Limited Company) provides examples of multi-layered film structures comprising a semi-crystalline polyamide PA6 layer, and a sealing layer which may comprise a polymer blend comprising an amorphous polyamide. The sealing layer enables the films to be compatible with automated packaging processes. Such films are shown to have high WTVR values, however do not match the visual properties of BOPP or CPP.

### SUMMARY OF THE INVENTION

The present inventors have developed enhanced packaging film structures which are suitable for retail packaging, and which overcome or reduce the problems previously mentioned. Such film structures utilise the properties of amorphous polyamides, and optionally amorphous polyesters, to enhance the properties of multi-layer films. The resulting film structures have good visual properties, which are similar to CPP and BOPP, are able to be machine processed and have a high tensile strength, and yet have water vapour transmission rates which enable them to expel excess moisture, provide a lower steady state headspace relative humidity and reduce the risk associated with free moisture forming in a produce package. Such a combination of features has previously been very difficult to achieve.

Accordingly, in a first aspect of the invention there is provided a packaging film suitable for packaging fresh produce, comprising a first layer of polymer film and a second layer of polymer film, and in which a first surface of the first layer of polymer film is adhered to a first surface of the second layer of polymer film, wherein:

the first layer of polymer film comprises an amorphous copolyamide, or a polyamide blend comprising at least one amorphous polyamide;

the second layer of polymer film comprises (i) an amorphous polyester; (ii) at least one of an ethylene-vinyl acetate copolymer (EVA), an ethylene-methyl acrylate copolymer (EMA), and an ethylene-butyl acrylate copolymer (EBA); or (iii) an amorphous copolyamide, or a polyamide blend comprising at least one amorphous polyamide; and wherein the packaging film has a water vapour transmission rate of between 15 and 150 g/m², preferably between 15 and 100 g/m², at 23° C. and 50% relative humidity.

The packaging films provide a combination of good visual properties and WVTR values suitable for the packaging of moisture sensitive fresh produce and may be customized to the produce and the supply chain length and conditions. Preferably, the packaging films have a clarity greater than or equal to 97% and/or a haze less than or equal to 3.5%.

In a second aspect of the invention there is provided the use of a packaging film as described herein for packaging fresh produce. The films have particular utility for retail packaging applications, such as use as lidding films and to form pillow packs and pre-formed bags, and provide particular benefits for the retail packaging of fresh produce which is sensitive to excess moisture within the produce package, such as avocados, green beans, berries, cucumbers, mangos, mushrooms, papayas, passion fruits, pomegranates or squash.

In a third aspect of the invention, there is provided a fresh produce package comprising a packaging film as described herein, such as a punnet or tray sealed with a packaging film as described herein, a pillow pack formed from a packaging film as described herein, or a pre-formed bag formed form a packaging film as described herein.

### BRIEF DESCRIPTION OF THE FIGURES

FIG. 1A to 1K show schematic representations of embodiments of the packaging films of the present invention.

### DETAILED DESCRIPTION OF THE INVENTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

### Packaging Films

The packaging films as described herein have water vapour transmission rates of between 15 and 150 g/m², preferably between 15 and 100 g/m², more preferably between 25 and 75 g/m². The water vapour transmission rate (WVTR) as used herein refers to the water vapour transmission rate determined according to ASTM E398, at 23° C. and 50% relative humidity.

The water vapour transmission rate of a polymer film may be adjusted for example by heat treating or orienting the film, as described in U.S. Pat. No. 6,190,710 which is hereby incorporated by reference in its entirety and in particular for the purpose of describing and defining ways of adjusting the water vapour transmission rate of a polymer film.

Typically, the packaging films have a haze value which is less than or equal to 3.5%, preferably less than or equal to 3.0%, more preferably less than or equal to 2.5%. Typically, the packaging films have a haze value which is greater than 0.5%, such as greater than 1%. The haze value may be measured by a hazemeter and as used herein refers to the haze value as determined according to ASTM D1003 Method A.

Typically, the packaging films have a clarity greater than or equal to 96%, preferably greater than or equal to 97%, more preferably greater than or equal to 98%. Typically, the packaging films have a clarity value which is less than 99.5%. The clarity of a polymer film may be measured using a haze meter and as used herein refers to the clarity value determined according to ASTM D1003 Method A.

Preferably, the packaging films have a haze value which is less than or equal to 3.5% and a clarity greater than or equal to 96%, or more preferably greater than or equal to 97%.

Typically, the packaging films have a sealing temperature which is greater than or equal to 135° C., preferably greater than or equal to 140° C. Preferably, the packaging films have a sealing temperature less than or equal to around 200° C. enabling use with conventional automated packing processes. The skilled person will understand that the sealing temperature of the packaging film refers to the sealing temperature of the layer of the film that, in use, is produce facing which is also known as the skin layer of the packaging film. As used herein, the term sealing temperature is intended to be the lowest temperature at which the skin layer in question will melt sufficiently to fuse to form a hermetic seal when subjected to heat and pressure in a heat sealing apparatus. The sealing temperature may be measured using a Laboratory Heat Sealer according to ASTM F2029 at constant pressure and sealing time. The pressure may be in the range from 0.05 MPa to 0.7 MPa (e.g. 0.5 MPa) and the sealing time may be in the range from 0.15 s to 0.5 s (e.g. 0.3 5). The sealing temperature may be determined across a range of temperatures, e.g. from 135° C. to 300° C. or 250° C.

The packaging films as described herein have a first layer and a second layer with a first surface of the first layer of polymer film is adhered to a first surface of the second layer of polymer film. The packaging films may also comprise a third layer of polymer film which is adhered to the second surface of the first layer or the second surface of the second layer.

The surfaces of the polymer films may be directly adhered (i.e. with no intermediate layer), or an intermediate tie layer may be present between the first and second layers and/or between the third and the first or second layers if applicable. The one or more intermediate tie layers are used to bind the polymer films together. Such layers may comprise, for example, modified polyethylene or modified ethylene-vinyl acetate copolymer, for example a maleic anhydride modified ethylene-vinyl acetate copolymer or a maleic anhydride modified polyethylene. In the case of maleic anhydride modified ethylene-vinyl acetate copolymer the vinyl acetate content may be, for example, in the range 9 to 28 wt % based on the total weight of the maleic anhydride modified ethylene-vinyl acetate copolymer intermediate tie layer.

Typically, the packaging films have a thickness of between 10 and 70 μm, preferably 15 and 60 μm, such as between 18 and 40 μm. The thickness of the first layer is typically between 5 and 90% of the total thickness of the packaging film, preferably between 10 and 90%, or 20 and 80%, or between 30 and 70% of the total thickness of the packaging film.

The first layer of polymer film may be composed of two or more sub-layers which taken together form the first layer of polymer film. The sub-layers may have identical composition to each other, or one or more of the sub-layers may have a different composition. For example, one or more of the sub-layers may include an additive or additives as described in more detail below. One or more of the sub-layers may be substantially free from additives. Typically, all of the sub-layers of the first layer of polymer film comprise the same polyamide material.

The first layer comprises an amorphous copolyamide, or a blend of two or more polyamides comprising at least one amorphous polyamide.

As used herein, the term polyamide refers to homopolyamides, copolyamides, or multipolyamides having an amide linkage between monomer units and which may be formed by methods known to those skilled in the art. Useful homopolyamides include PA6 (polycaprolactam), PA66 (Polyhexamethylene adipamide), PA12 (Polydodecanolactam), PA69 (Polyhexamethylene azelaamide), PA610 (hexamethylene sebacamide), PA11 (Poly(l1 aminoundecanoamide), PA612 Poly(hexamethylene dodecanoamide), and the like. Useful copolymers include PA6/66 (polycaprolactam/hexamethylene adipamide copolymer), PA6I/6T (a copolymer of hexamethylene diamine with teraphthalic acid and isophthalic acid), and the like. Useful multi-polyamides include PA66/69/610/6I. The skilled person will understand that PA6I (included in multi-polyamide PA66/69/610/6I) is polyhexamethylene isophthalamide.

As used herein the term amorphous refers to polymers which are lacking in crystallinity as shown by a lack of an endotherm crystalline melting peak in a Differential Scanning Calorimeter (DSC) test. Useful amorphous polyamides include PA6I/6T (polyphthalamide) copolymer and PA66/69/610/6I.

In the first layer the amorphous polyamide is typically blended with at least one semi-crystalline polyamide. Useful semi-crystalline polyamides include PA6, PA66, PA12, PA69, PA610, PA11, PA612, and PA6/66.

Typically, the first layer comprises at least 85 wt % of polyamide material based on the total weight of the components of the first layer, such as between 85 and 100 wt %. The first layer typically contains at least 5 wt % of amorphous polyamide based on the total weight of the components of the first layer, preferably at least 7 wt %, at least 9 wt %, at least 12 wt %, or at least or 15 wt %. The first layer may contain 100 wt % or less of amorphous polyamide based on the total weight of the components of the first layer, preferably 30 wt % or less or 25 wt % or less.

Preferably the first layer comprises:
(i) copolyamide PA6I/6T;
(ii) a copolyamide, such as PA6/66 or PA6I/6T, and an amorphous multipolyamide, such as PA66/69/610/6I; or
(iii) a blend of two or more polyamides comprising at least one amorphous polyamide, for example a blend of polyamides selected from the group consisting of PA6 (polycaprolactam), PA66 (Polyhexamethylene adipamide), PA12 (Polydodecanolactam), PA69 (Polyhexamethylene azelaamide), PA610 (hexamethylene sebacamide), PA11 (Poly(l1 aminoundecanoamide), PA612 Poly(hexamethylene dodecanoamide), PA6/66, PA6I/6T, and PA66/69/610/6I.

Particularly suitable is a blend of PA6 with PA6I/6T, a blend of PA6/66 with PA66/69/610/6I, or a blend of PA6 and PA6/66 with PA6I/6T.

Where a copolyamide is combined with a multipolyamide, typically the first layer includes 10-90 wt % of copolyamide and 10-90 wt % of multipolyamide.

A first surface of the first layer of polymer film is adhered to a first surface of the second layer of polymer film. The second layer of polymer film may be composed of two or more sub-layers which taken together form the second layer of polymer film. The sub-layers may have identical composition to each other, or one or more of the sub-layers may have a different composition. For example, one or more of the sub-layers may include an additive or additives as described in more detail below. One or more of the sub-layers may be substantially free from additives. Typically, all of the sub-layers comprise the same polymer. In some embodiments, it may be preferred that the second layer of polymer film is formed from a single layer (i.e. does not comprise sub-layers).

In one embodiment of the invention the second layer comprises an amorphous polyester. As used herein, the term polyester refers to homopolymers and copolymers having an ester linkage between monomer units which may be formed, for example, by condensation polymerisation reactions between a dicarboxylic acid and a glycol. The dicarboxylic acid may be linear or aliphatic, or may be aromatic or alkyl substituted aromatic, e.g. various forms of phthalic acid. The polyesters of the current invention are not poly(ester amide)s (PEAs).

As used herein, the term amorphous refers to polyesters which are lacking in crystallinity as shown by a lack of an endotherm crystalline melting peak in a Differential Scanning Calorimeter (DSC) test.

Typically, the second layer comprises at least 70 wt % of amorphous polyester based on the total weight of the components of the second polymer layer, such as between 70 and 100 wt %. The second layer may comprise at least 70 wt % of a copolyester based on the total weight of the components of the second polymer layer, such as between 70 and 100 wt %. Preferably, the second layer comprises at least one of an amorphous polyethylene terephthalate (PET) or a polyethylene terephthalate glycol modified (PETG). More preferably the second layer comprises between 70 and 100 wt % of PETG.

In a preferred embodiment, the packaging film comprises a first layer comprising an amorphous polyamide, preferably a blend of at least two polyamides, such as PA6 and PA6I/6T, or PA6, PA6/66 and PA6I/6T, and a first surface of the first layer is adhered to first surface of a second layer comprising an amorphous polyester, preferably an amorphous PET or PETG.

Optionally, the second surface of the first layer is attached to a third layer comprising a polyester, preferably PET or PETG; a third layer comprising polyethylene, an ethylene-vinyl acetate copolymer (EVA), an ethylene-methyl acrylate copolymer (EMA), or an ethylene-butyl acrylate copolymer (EBA); a third layer comprising a semi-crystalline polyamide, preferably PA6 and/or a polyamide MXD6 polymer; or a third layer comprising one or more styrene copolymers, optionally blended with PS (polystyrene) or HIPS (high impact polystyrene), for example one or more styrene copolymers selected from the group consisting of SBS (styrene butadiene styrene copolymer), SBC (styrene butadiene copolymers), SEBS (styrene ethylene butylene styrene), SEPS (styrene ethylene propylene styrene), SIS (styrene isoprene copolymers).

The use of a semi-crystalline polyamide in the third layer can provide packaging films in which the outer layer has good thermal resistance ensuring the outer layer maintains good mechanical properties during the sealing process (in which the skin layer is melted). The use of one or more styrene copolymers, such as SBS, in the third layer may be advantageous as the mechanical properties of styrene co-polymers are not affected by surrounding humidity.

In a further embodiment of the invention, the second layer comprises an ethylene-vinyl acetate copolymer (EVA), an ethylene-methyl acrylate copolymer (EMA), an ethylene-butyl acrylate copolymer (EBA) or blends thereof. In such cases, a bonding agent may be added to the second layer of polymer film to enhance bonding. The skilled person is familiar with the selection of suitable bonding agents. Bonding agent is typically added at a level of 5-20 wt %, e.g. 7-15 wt % with respect to the total weight of the second layer. Suitable bonding agents are modified polyethylenes e.g. a modified linear low density polyethylene, or modified EVA. The polyethylene or EVA may be modified with maleic anhydride. A suitable bonding agent is Bondyram 9201 available from Polyram. Typically, the second layer comprises at least 80 wt % of ethylene-vinyl acetate copolymer, ethylene-methyl acrylate copolymer, and/or the ethylene-butyl acrylate copolymer based on the total weight of the components of the second layer, preferably at least 90 wt %.

In another preferred embodiment, the packaging film comprises a first layer comprising a copolyamide or a blend of polyamides, preferably a blend of PA6 and PA6I/6T, and a first surface of the first layer is adhered to a second layer comprising an ethylene-vinyl acetate copolymer (EVA), an ethylene-methyl acrylate copolymer (EMA), or an ethylene-butyl acrylate copolymer (EBA). Optionally, the second surface of the second polymer layer is attached to a third layer comprising a polyamide. Preferably the third layer, comprises:
(i) copolyamide PA6I/6T;
(ii) a copolyamide, such as PA6/66 or PA6I/6T, and an amorphous multipolyamide, such as PA66/69/610/6I; or
(iii) a blend of two or more polyamides comprising at least one amorphous polyamide, for example a blend of polyamides selected from the group consisting of PA6 (polycaprolactam), PA66 (Polyhexamethylene adipamide), PA12 (Polydodecanolactam), PA69 (Polyhexamethylene azelaamide), PA610 (hexamethylene sebacamide), PA11 (Poly(l1 aminoundecanoamide), PA612 Poly(hexamethylene dodecanoamide), PA6/66, PA6I/6T, and PA66/69/610/6I

The first, second and/or third layers may include one or more additives.

For example, anti-block additive may be added to reduce the risk of blocking, which is the adhesion of two adjacent layers of film. Anti-block additive may be provided to the first, second and/or third layers. Typically, it is provided to one or more sub-layers, in an amount of 0.1-5 wt % with respect to the total weight of that sub-layer. The skilled person will be familiar with the selection of suitable anti-block additives. Suitable anti-block additives include Ultramid B40LN available from BASF, and Styrolux NB10 available from Styrolution.

An anti-fog additive may be added to reduce fogging of the layered packaging film. The anti-fog additive may be added to any one of the layers or sub-layers, e.g. at a level of 0.1-20 wt % with respect to the total weight of the layer or sub-layer to which it is added, e.g. at a level of 0.5-15 wt %. The skilled person will be familiar with the selection of suitable anti-fog additives. Suitable anti-fog additives include Polybatch AF1088 (a polyolefin based anti-fog additive) available from A. Shulman.

A Slip-/Anti-block masterbatch may be used to lower the coefficient of friction (COF) and to avoid blocking of the films. The Slip additive may be added to any one of the layers or sub-layers, e.g. at a level of 0.1-10 wt % with respect to the total weight of the layer or sub-layer to which it is added, e.g. at a level of 0.5-10 wt %. The skilled person will be familiar with the selection of suitable slip additives. Suitable slip additives include GSA3022ST (based on PETG polymer with anti-block particles and wax) available from IQAP masterbatch.

An anti-fog coating may optionally be applied to the film, typically on the surface of the skin layer.

The particular layers that are chosen for any particular fresh produce packaging application is determined by factors such as the produce to be packed, the supply chain length and conditions, the sensitivity of the produce to excess moisture, the sensitivity of the produce to dehydration and the surface area to volume ratio.

Typically, the layered packaging film of the present invention is perforated to provide suitable O₂ and CO₂ permeability for the fresh produce which is to be packaged, as described in U.S. Pat. No. 6,190,710 which is hereby incorporated by reference in its entirety and in particular for the purpose of describing the perforation of packaging films to increase O₂ and CO₂ permeability. The number, size and pattern of the perforations required depend on factors including the respiration rate of the produce to be packed , anticipated supply chain conditions and the desired modified atmosphere.

For example, the packaging film may be microperforated to provide holes having a diameter of about 0.03-1 mm diameter at a density of up to about 2000 holes per square metre of material. Preferably, the packaging film is microperforated to provide holes having a diameter of about 0.03-0.15 mm diameter at a density of up to about 500 holes per square metre of material. Microperforations are typically provided by laser, or alternatively may be formed using metal or ceramic needles for example.

Typically, the layered packaging film of the present invention is formed by extruding a first polymer for forming the first layer and a second polymer for forming the second layer and forming the first and second polymers into a layered film. Typically, the first and second polymers are extruded simultaneously (co-extruded). The extrusion is typically through annular film dies, e.g. with manifolds for the different layers being located at different radial distances from the centre of the die. Air is typically injected into the centre of the die to inflate a bubble of extruded polymer. The bubble is typically then cooled and collapsed to form a flat film. The layered packaging film is typically rolled to provide a roll of packaging film once cooled. The skilled person will be familiar with techniques for forming layered polymer films by extrusion.

Packaging Film Structures

The following are non-limiting embodiments of packaging film structures of the invention. In each case the polyamide materials form the first layer, and third layer if applicable and unless stated otherwise, are preferably selected from copolyamide PA6I/6T; a copolyamide, such as PA6/66 or PA6I/6T, and an amorphous multipolyamide, such as PA66/69/610/6I; or a blend of two or more polyamides comprising at least one amorphous polyamide, for example a blend of polyamides selected from the group consisting of PA6 (polycaprolactam), PA66 (Polyhexamethylene adipamide), PA12 (Polydodecanolactam), PA69 (Polyhexamethylene azelaamide), PA610 (hexamethylene sebacamide), PA11 (Poly(11 aminoundecanoamide), PA612 Poly(hexamethylene dodecanoamide), PA6/66, PA6I/6T, and PA66/69/610/6I. It may be preferred that the polyamide materials comprise PA6 and PA6I/6T, or PA6, PA6/66 and PA6I/6T.

In each case the skin layer forms the produce facing side of the packaging film. In each case the skin layer has a sealing temperature which is greater than or equal to 135° C.

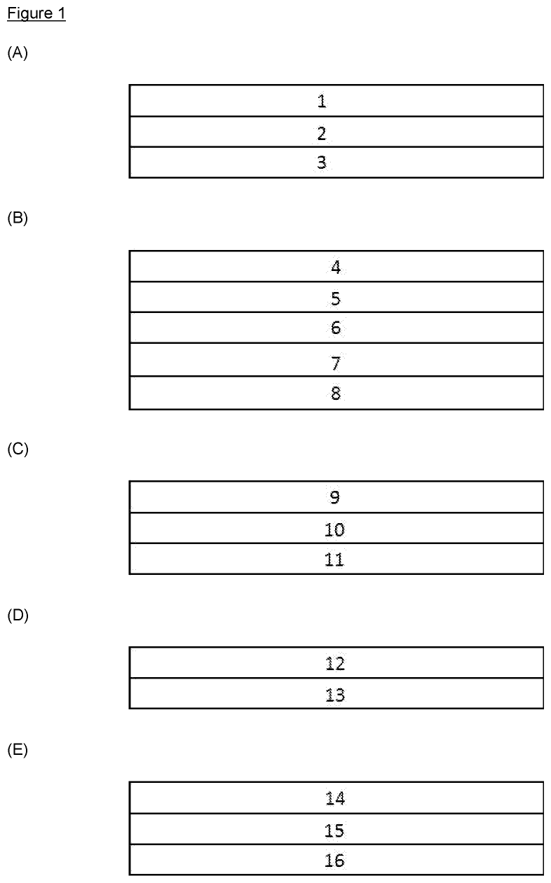

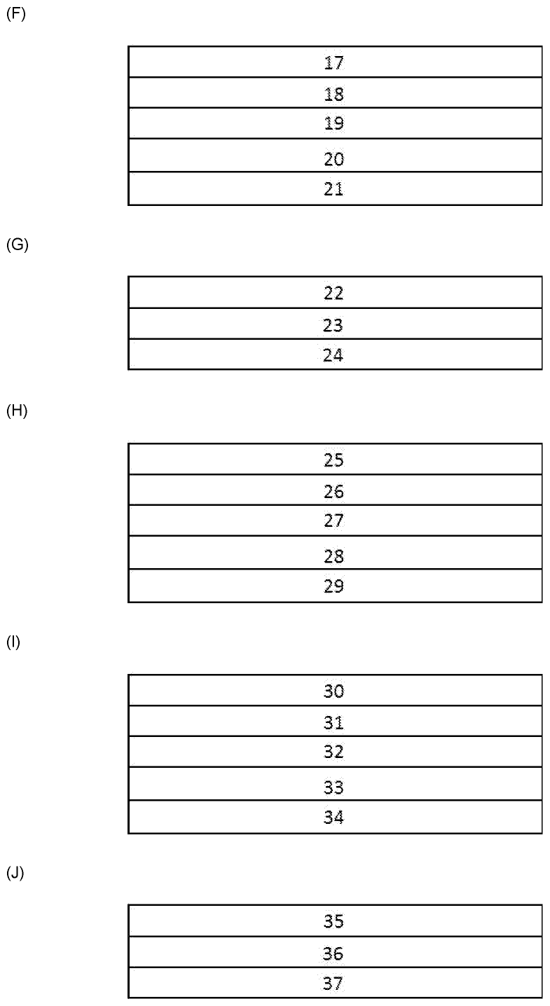

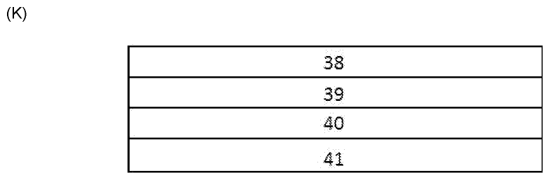

Packaging film structure (A): A schematic of the structure of this packaging film is shown in FIG. 1A. In this embodiment, the first layer 1 is the skin layer which comprises a polyamide, and preferably an anti-fog additive. The second layer 2 is the core layer which comprises EVA, EBA and/or EMA and a bonding agent, such as a maleic anhydride modified polyethylene or a maleic anhydride modified EVA. The third outer layer 3 comprises polyamide.

Packaging film structure (B): A schematic of the structure of this packaging film is shown in FIG. 1B. In this embodiment, the first layer 4 is the skin layer which comprises polyamide, and preferably an anti-fog additive. The second layer 6 is the core layer which comprises EVA, EBA and/or EMA. The third outer layer 8 comprises a polyamide. The layers are bonded together with intermediate tie layers (5,7), which preferably comprise a maleic anhydride modified polyethylene or a maleic anhydride modified EVA.

Packaging film structure (C): A schematic of the structure of this packaging film is shown in FIG. 1C. In this embodiment, the first layer 11 is the outer layer which comprises polyamide. The second layer 9 is the skin layer which comprises EVA, EBA, EMA and/or polyethylene, such as low-density polyethylene (LDPE) or linear low-density polyethylene (LLDPE), preferably with an anti-fog additive. The layers are bonded together with an intermediate tie layer 10, which preferably comprises a maleic anhydride modified polyethylene or a maleic anhydride modified EVA.

Packaging film structure (D): A schematic of the structure of this packaging film is shown in FIG. 1D. In this embodiment, the first layer 13 is the outer layer which comprises polyamide. The second layer 12 is the skin layer which comprises EVA, EBA, EMA and/or polyethylene, such as low-density polyethylene (LDPE) or linear low-density polyethylene (LLDPE), and a bonding agent, such as a maleic anhydride modified polyethylene or a maleic anhydride modified EVA, preferably with an anti-fog additive.

Packaging structure (E): A schematic of the structure of this packaging film is shown in FIG. 1E. In this embodiment, the first layer 16 is the outer layer which comprises polyamide. The second layer 14 is the skin layer and comprises an amorphous polyester, preferably PET and/or PETG, and preferably an anti-fog additive. Alternatively, the anti-fog additive may be applied to the surface of the skin layer as a coating. The layers are bonded together with an intermediate tie layer 15, which preferably comprises maleic anhydride modified polyethylene or a maleic anhydride modified EVA.

Packaging structure (F): A schematic of the structure of this packaging film is shown in FIG. 1F. In this embodiment, the first layer 19 is the core layer which comprises polyamide. The second layer 17 is the skin layer and comprises an amorphous polyester, preferably PET or PETG, and preferably an anti-fog additive. Alternatively, the anti-fog additive may be applied to the surface of the skin layer as a coating. The third layer 21 is the outer layer which comprises an amorphous polyester, preferably PET and/or PETG. The layers are bonded together with intermediate tie layers (18, 20) which preferably comprise maleic anhydride modified polyethylene or a maleic anhydride modified EVA.

Packaging structure (G): A schematic of the structure of this packaging film is shown in FIG. 1G. In this embodiment, the first layer 22 is the skin layer which comprises polyamide, preferably with an anti-fog additive. The second layer is the outer layer 24 and comprises an amorphous polyester, preferably PET and/or PETG. The layers are bonded together with an intermediate tie layer 23, which preferably comprises maleic anhydride modified polyethylene or a maleic anhydride modified EVA.

Packaging structure (H): A schematic of the structure of this packaging film is shown in FIG. 1H. In this embodiment, the first layer 29 is the outer layer which comprises polyamide. The second layer 27 is the core layer which comprises an amorphous polyester, preferably PET and/or PETG. The third layer 25 is the skin layer which comprises EVA, EBA, EMA, a maleic anhydride modified EVA, and/or polyethylene, such as low-density polyethylene (LDPE) or linear low-density polyethylene (LLDPE), preferably with an anti-fog additive. The layers are bonded together with intermediate tie layers (26, 28) which preferably comprise maleic anhydride modified polyethylene or a maleic anhydride modified EVA.

Packaging structure (I): A schematic of the structure of this packaging film is shown in FIG. 1I. In this embodiment, the first layer 30 is the skin layer and comprises polyamide, preferably with an anti-fog additive. The second layer 32 is the core layer which comprises an amorphous polyester, preferably PET and/or PETG. The third layer 34 is the outer layer and comprises a polyamide, preferably a crystalline polyamide resin, more preferably PA6 (polycaprolactam) and/or MXD6 (m-xylene diamine). The layers are bonded together with intermediate tie layers (31, 33) which preferably comprise maleic anhydride modified polyethylene or a maleic anhydride modified EVA.

Packaging structure (J): A schematic of the structure of this packaging film is shown in FIG. 1J. In this embodiment, the first layer 35 is the skin layer and comprises polyamide, preferably with an anti-fog additive. Preferably, the first layer comprises PA6/66 in a blend with PA66/69/610/6I. The second layer 36 is the core layer and comprises polyamide, preferably a blend of PA6 and PA6I/6T. The third layer is the skin layer and comprises polyamide, preferably a blend of PA6 and PA6I/6T.

Packaging structure (K): A schematic of the structure of this packaging film is shown in FIG. 1L. In this embodiment, the first layer 40 is the core layer which comprises polyamide. The second layer 38 is the skin layer and comprises an amorphous polyester, preferably PET or PETG and preferably an anti-fog additive. Alternatively, the anti-fog additive may be applied to the surface of the skin layer as a coating. The third layer 41 is the outer layer which comprises SBC. The first layer and second layer are bonded together with an intermediate tie layer (39) which preferably comprises maleic anhydride modified polyethylene or a maleic anhydride modified EVA.

Retail Packaging

The packaging films described herein have particular utility for the retail packaging of fresh produce, such as fruit and vegetables. The combination of enhanced visual properties and WVTR may be particularly advantageous for the packaging of moisture sensitive and/or dehydration sensitive fresh produce in retail packaging at source. Typically, the films may be laser perforated in accordance with the respiration rate of the produce to be packed in order to provide a permeability that will ensure the desired modified atmosphere when the packaging is packed with the produce under the prevailing supply chain conditions.

The packaging films may be advantageously used as lidding films for sealing fresh produce packages, such as punnets or trays, for example punnets or trays containing berries. Film structures (D), (E), (F), (H), and (K) as hereinbefore described are in certain instances of particular utility for this application as the materials in the skin layer are compatible for sealing to polypropylene and polyester punnets and trays, which are the most commonly used materials.

The packaging films may also be advantageously used to form pillow packs, for example pillow packs containing avocado, asparagus, beans, cucumbers, peas, mango, passion fruit, papaya, bell peppers or tomatoes. Film structures (A), (B), (C), (D), (E), (F), (G), (H), (I), (J), and (K) as hereinbefore described are of particular utility for this application.

The packaging films may also be advantageously used to form preformed bags. Film structures (A), (B), (C), (D), (E), (F), (G), (H), (I), (J), and (K) as hereinbefore described are of particular utility for this application.

The packaging films may be advantageously used for packaging passion fruit. In one embodiment of the invention there is provided a retail package, such as a pillow pack, containing at least one passion fruit, the retail package comprising a packaging film as described herein, such as a film structure selected from one of film structures (A) to (K) as hereinbefore described. Typically, such retail packages contain up to three passion fruits and/or contain a produce weight of 150-200 g.

### EXAMPLES

The following materials were used in the Examples below:

| | |
|---|---|
| Copolymer 1 | PA6/66 - available from BASF under brand name |
| | Ultramid C33 LN (Examples 1 and 2), C40 LN |
| | (Example 5 and 6) |
| Copolymer 2 | PA6I/6T - available from EMS-CHEMIE AG under |
| | brand name Grivory G21 |
| Multipolymer | PA66/69/610/6I - available from EMS-CHEMIE AG |
| | under brand name Grilon BM16 |
| PA6 | Available from BASF under brand name Ultramide |
| (polycaprolactam) | B40LN or available from DSM under brand name |
| | Akulon F136-E1 |
| Anti-Block/Slip | Available from BASF under brand name Sicopas 448 |
| Additive 1 | |
| Anti-Block/Slip | Available from IQAP masterbatch under brand name |
| Additive 2 | GSA3022ST |
| Anti-Block/Slip | MB3361 |
| Additive 3 | |
| Anti-Fog Additive | Available from Shulman under brand name |
| | Polybatch AF1088 |
| PETG | Available from Selenis under brand name GG174 |
| Maleic Anhydride | Available from Polyram under brand name |
| modified EVA in | Bondyram TL9201 |
| 27% VA content | |
| (Bonding agent 1) | |
| Anti-fog coating | Available from INX International Ink Co under |
| concentrate | brand name Antifog Coating concentrate 1309444 |
| SBC (Styrene | Available from Ineos Styrolution under brand name |
| Butadiene | K-Resin DK11 |
| Copolymer) | |

Layered packaging films according to the present invention were prepared by extrusion through blown film dies. Extruders were used to melt and push molten resin into an annular film die. Each layer was formed by separate spiral mandrel manifold at a different radial distance from the centre of the die. Air was injected into the centre of the annular die to inflate the polymer bubble. The bubble was cooled by an air ring that blows air on the surface of the bubble to lower its temperature until it solidifies. Above the die, a stabilizing cage was used to minimize movement of the bubble as it was collapsed in the collapsing frame to make a flat film. This film was then pulled over rolls and fed into a film winder to make the finished film roll.

The following temperature profile was used to prepare the layered film in Example 1:

| | Barrel zones, ° C. | | | | Screen | Adaptor, | |
|---|---|---|---|---|---|---|---|
| | 1 | 2 | 3 | 4 | Changer, ° C. | ° C. | Die, ° C. |
| A skin-Layer | 200 | 210 | 230 | 240 | 245 | 245 | 245 |
| B | 230 | 245 | 250 | 250 | 250 | 250 | 250 |
| C | 230 | 245 | 250 | 250 | 250 | 250 | 250 |
| D | 180 | 195 | 200 | 200 | 200 | 200 | 225 |
| E | 230 | 240 | 240 | 240 | 240 | 240 | 240 |

The following temperature profile was used to prepare the layered film in Example 2:

| | Barrel zones, ° C. | | | | Screen | Adaptor, | |
|---|---|---|---|---|---|---|---|
| | 1 | 2 | 3 | 4 | Changer, ° C. | ° C. | Die, ° C. |
| A skin-Layer | 200 | 210 | 230 | 240 | 245 | 245 | 245 |
| B | 230 | 245 | 250 | 250 | 250 | 250 | 250 |
| C | 230 | 245 | 250 | 250 | 250 | 250 | 250 |
| D | 230 | 245 | 250 | 250 | 250 | 250 | 250 |
| E | 230 | 245 | 250 | 250 | 250 | 250 | 250 |

The following temperature profile was used to prepare the layered film in Example 3,4,5:

| | Barrel zones, ° C. | | | | Screen | Adaptor, | |
|---|---|---|---|---|---|---|---|
| | 1 | 2 | 3 | 4 | Changer, ° C. | ° C. | Die, ° C. |
| A | 225 | 250 | 250 | 250 | 250 | 250 | 250 |
| B | 225 | 250 | 250 | 250 | 250 | 250 | 250 |
| C | 225 | 250 | 250 | 250 | 250 | 250 | 250 |
| D | 180 | 190 | 200 | 200 | 200 | 200 | 200 |
| E seal-Layer | 220 | 240 | 240 | 240 | 240 | 240 | 240 |

The following temperature profile was used to prepare the layered film in Example 6:

| | Barrel zones, ° C. | | | | Screen | Adaptor, | |
|---|---|---|---|---|---|---|---|
| | 1 | 2 | 3 | 4 | Changer, ° C. | ° C. | Die, ° C. |
| A skin-Layer | 160 | 170 | 180 | 190 | 210 | 210 | 210 |
| B | 230 | 245 | 250 | 250 | 250 | 250 | 250 |
| C | 230 | 245 | 250 | 250 | 250 | 250 | 250 |
| D | 230 | 245 | 250 | 250 | 250 | 250 | 250 |
| E | 220 | 240 | 240 | 240 | 240 | 240 | 240 |

Testing Methods

Thickness was measured at 24 points across the width of the film using a Millimess Inductive Digital Comparator Extramess 2001

WVTR was measured at 23° C. and 50% relative humidity according to ASTM E398

Seal strength was measured according to ASTM F88. A 15-mm width sample of film containing the seal is cut out from the bag. Each tail of the sealed specimen is secured in the opposing grips of a Lloyd LRX tensile tester. The maximum tensile force required to separate the two ends of the seal was recorded.

Sealing temperature range was measured using a Laboratory Heat Sealer according to ASTM F2029 at constant pressure and time. Dwell time was 0.15-0.5 s in a temperature range of 150-200° C.

Clarity and Haze on an 8 cm diameter film sample was measured using a Gardner haze-gard plus hazemeter according to ASTM D1003 Method A.

Tensile strength at break in both machine direction (MD) and traverse direction (TD) was measured according to ASTM D-882 using a Lloyd LRX tensile tester. A 15-mm width sample of film was taken and secured in opposing grips of the tensile tester. The maximum tensile force required to break the strip of film was recorded.

Elongation at break in both machine direction (MD) and traverse direction (TD) was measured according to ASTM D-882 using a Lloyd LRX tensile tester. A 15-mm width sample of film was taken and secured in opposing grips of the tensile tested. The percentage elongation of the film at break was recorded.

### Example 1

A multi-layer film was produced with the following film structure:

| | | % by weight | Layer |
|---|---|---|---|
| Layer | Material | in Layer | distribution % |
| Skin | PA6/66 | 68 | 5 |
| layer | PA66/69/610/6I | 20 | |
| | Anti-block additive 1 | 4 | |
| | Anti-fog additive | 8 | |
| Core | PA6 | 67 | 20 |
| layer | PA6I/6T | 20 | |
| | Anti-fog additive | 8 | |
| Core | PA6 | 80 | 20 |
| layer | PA6I/6T | 20 | |
| Tie | Maleic Anhydride modified | 100 | 5 |
| layer | EVA in 27% VA content | | |
| Outer | Amorphous PETG | 98 | 50 |
| layer | Anti-block and Slip agent's | 2 | |
| | additive 2 | | |

The film produced in Example 1 was tested to determine the properties of the film. The results are shown in Table 1 together with values for BOPP and CPP films. The film of Example 1 shows a high clarity and a comparable haze value to those typically obtained with BOPP and CPP films. The WVTR however is significantly higher.

TABLE 1
The results of the testing of the film of Example 1

| PROP- | TEST | | | VALUE | | Exam- |
|---|---|---|---|---|---|---|
| ERTIES | METHOD | UNIT | | BOPP | CPP | ple 1 |
| Nominal | ASTM D-374 | Micron | | 35 | 35 | 35 |
| Thickness | | | | | | |
| (±3%) | | | | | | |
| Clarity | ASTM D-1003 | % | | 97 | >85 | 97 |
| | Method A | | | | | |
| Haze | ASTM D-1003 | % | | 2.5 | 3.5 | 2.5 |
| | Method A | | | | | |
| Tensile | ASTM D-882 | Kg/cm² | MD² | 1250 | 1500 | 4500 |
| Strength | | | TD³ | 2800 | 3000 | 6000 |
| at Break | | | | | | |
| Elongation | ASTM D-882 | % | MD | 200 | 300 | 350 |
| at Break | | | TD | 85 | 400 | 450 |

| | | | | | |
|---|---|---|---|---|---|
| WVTR | E398 | gr/m² × day | 3.5 | 2 | ≥30 |
| (38° C., | | | | | |
| 90% RH) | | | | | |
| WVTR | E398 | gr/m² × day | | | 40-50 |
| (23° C., | | | | | |
| 50% RH) | | | | | |
| Seal | Internal | ° C. | 125 | 125 | 140 |
| Temperature | | | | | |

### Example 2

A multi-layer film was produced with the following film structure:

| Layer | Material | WT % in Layer | Layer distribution % |
|---|---|---|---|
| Skin | PA6/66 | 68 | 5 |
| Layer | PA66/69/610/6I | 20 | |
| | Anti-block additive | 4 | |
| | Anti-fog additive | 8 | |
| Core | PA6 | 67 | 20 |
| layer | PA6I/6T | 20 | |
| | Anti-fog additive | 8 | |
| Core | PA6 | 80 | 30 |
| layer | PA6I/6T | 20 | |
| Core | PA6 | 80 | 25 |
| layer | PA6I/6T | 20 | |
| Outer | PA6 | 76 | 20 |
| layer | PA6I/6T | 20 | |
| | Slip agent | 2 | |
| | Anti-block agent | 2 | |

The film produced in Example 2 was tested to determine the properties of the film. The results are shown in Table 2. The film of Example 1 shows a very high clarity and a comparable haze value to BOPP and CPP films. The WVTR however is significantly higher.

| PROPERTIES | TEST METHOD | UNIT | | Value |
|---|---|---|---|---|
| Nominal Thickness (±3%) | ASTM D-374 | Micron | | 35 |
| Clarity | ASTM D-1003 | % | | 98 |
| | Method A | | | |
| Haze | ASTM D-1003 | % | | 3 |
| | Method A | | | |
| Tensile Strength at Break | ASTM D-882 | Kg/cm² | MD² | 9000 |
| | | | TD³ | 7500 |
| Elongation at Break | ASTM D-882 | % | MD | 600 |
| | | | TD | 550 |

| | | | |
|---|---|---|---|
| WVTR(38° C., 90% RH) | E398 | gr/m² × day | ≥49 |
| WVTR(23° C., 50% RH) | E398 | gr/m² × day | 50-64 |
| Sealing temperature | Internal | ° C. | 140 |

### Example 3

Multi-layer films were produced at 25 μm and 35 μm thickness with the following film structure:

| | | % by weight | Layer |
|---|---|---|---|
| Layer | Material | in Layer | distribution % |
| Outer | PA6 | 76 | 15 |
| layer | PA6I/6T | 20 | |
| | Anti-block and Slip agent's | 4 | |
| | additive 3 | | |
| Outer | PA6 | 80 | 20 |
| layer | PA6I/6T | 20 | |
| Outer | PA6 | 80 | 35 |
| layer | PA6I/6T | 20 | |
| Tie | Maleic Anhydride modified | 100 | 5 |
| layer | EVA in 27% VA content | | |
| Skin | Amorphous PETG | 97 | 25 |
| Layer | | | |
| | Anti-block and Slip agent's | 3 | |
| | additive 2 | | |
| Coating | Antifog coating concentrate | | |

### Example 4

Multi-layer films were produced at 25 μm and 35 μm thickness with the following film structure:

| | | % by weight | Layer |
|---|---|---|---|
| Layer | Material | in Layer | distribution % |
| Outer | PA6 | 76 | 15 |
| layer | PA6I/6T | 20 | |
| | Anti-block and Slip agent's | 4 | |
| | additive 3 | | |
| Outer | PA6 | 80 | 20 |
| layer | PA6I/6T | 20 | |
| Outer | PA6 | 80 | 20 |
| layer | PA6I/6T | 20 | |
| Tie | Maleic Anhydride modified | 100 | 5 |
| layer | EVA in 27% VA content | | |
| Skin | Amorphous PETG | 97 | 40 |
| Layer | | | |
| | Anti-block and Slip agent's | 3 | |
| | additive 2 | | |
| Coating | Antifog coating concentrate | | |

### Example 5

A multi-layer film was produced with the following film structure:

| | | % by weight | Layer |
|---|---|---|---|
| Layer | Material | in Layer | distribution % |
| Outer | PA6 | 66 | 15 |
| layer | PA6/66 | 20 | |
| | PA6I/6T | 10 | |
| | Anti-block and Slip agent's | 4 | |
| | additive 3 | | |
| Outer | PA6 | 70 | 20 |
| layer | PA6I/6T | 10 | |
| | PA6/66 | 20 | |
| Outer | PA6 | 80 | 35 |
| layer | PA6I/6T | 10 | |
| | PA6/66 | 20 | |
| Tie | Maleic Anhydride modified | 100 | 5 |
| layer | EVA in 27% VA content | | |
| Skin | AmorphousPETG | 97 | 25 |
| Layer | | | |
| | Anti-block and Slip agent's | 3 | |
| | additive 2 | | |
| Coating | Antifog coating concentrate | | |

Examples 3-5 were tested to determine their film properties. The results are shown in Table 3 below. The film of Example 1 shows a very high clarity and a comparable haze value to BOPP and CPP films. The WVTR however is significantly higher.

TABLE 3
The results of the testing of the film of Examples 3 to 5.

| | TEST | | | VALUE | Example | | | |
|---|---|---|---|---|---|---|---|---|
| PROPERTIES | METHOD | UNIT | | 3 | | 4 | | 5 |
| Nominal Thickness | ASTM D- | Micron | | 25 | 35 | 25 | 35 | 25 |
| (±3%) | 374 | | | | | | | |
| Clarity | ASTM D- | % | | 97 | | | | |
| | 1003 | | | | | | | |
| | Method A | | | | | | | |
| Haze | ASTM D- | % | | 2.5 | | | | |
| | 1003 | | | | | | | |
| | Method A | | | | | | | |
| Tensile Strength at | ASTM D- | Kg/cm² | MD² | 8000 | 7000 | 6500 | 6500 | 5500 |
| Break | 882 | | TD³ | 7400 | 6500 | 5500 | 6200 | 5300 |
| Elongation at Break | ASTM D- | % | MD | 450 | 520 | 370 | 420 | 450 |
| | 882 | | TD | 430 | 480 | 400 | 420 | 450 |

| | | | | | | | |
|---|---|---|---|---|---|---|---|
| WVTR(38° C., 90% RH) | E398 | gr/m² × day | — | — | — | — | — |
| WVTR(23° C., 50% RH) | E398 | gr/m² × day | 100 | 50 | 50 | 23 | 100 |

| | | | |
|---|---|---|---|
| Seal Temperature | Internal | ° C. | 140 |

### Example 6

A multi-layer film was produced with the following film structure:

| | | % by weight | Layer |
|---|---|---|---|
| Layer | Material | in Layer | distribution % |
| Outer | SBC | 100 | 15 |
| layer | | | |
| Core | PA6 | 70 | 20 |
| layer | PA6I/6T | 10 | |
| | PA6/66 | 20 | |
| Core | PA6 | 80 | 35 |
| layer | PA6I/6T | 10 | |
| | PA6/66 | 20 | |
| Tie | Maleic Anhydride modified | 100 | 5 |
| layer | EVA in 27% VA content | | |
| Skin | PETG | 97 | 25 |
| Layer | | | |
| | Anti-block and Slip agent's | 3 | |
| | additive | | |
| Coating | Anti-fog coating concentrate | | |

Based on their understanding of the current invention and the properties of the components, the present inventors have produced a film structure in Example 6 selected to provide a water vapour transmission rate of between 15 and 150 g/m² at 23° C. and 50% relative humidity, in combination with a clarity greater than or equal to 97% and a haze of less than or equal to 3.5%.

1. A packaging film suitable for packaging fresh produce, comprising a first layer of polymer film and a second layer of polymer film, and in which a first surface of the first layer of polymer film is adhered to a first surface of the second layer of polymer film, wherein:
the first layer of polymer film comprises an amorphous copolyamide or a polyamide blend comprising at least one amorphous polyamide;
the second layer of polymer film comprises:
(i) an amorphous polyester;
(ii) at least one of an ethylene-vinyl acetate copolymer, an ethylene-methyl acrylate copolymer, and an ethylene-butyl acrylate copolymer; or
(iii) an amorphous copolyamide, or a polyamide blend comprising at least one amorphous polyamide;
and wherein the packaging film has a water vapour transmission rate of between 15 and 150 g/m² at 23° C. and 50% relative humidity.

2. A packaging film according to claim 1 wherein the packaging film has a haze of less than or equal to 3.5%.

3. A packaging film according to claim 1 or claim 2 wherein the packaging film has a sealing temperature greater than or equal to 135° C.

4. A packaging film according to any preceding claim 1 wherein the packaging film has a clarity greater than or equal to 97%.

5. A packaging film according to any preceding claim 1 wherein the second layer of polymer film comprises an amorphous polyester.

6. A packaging film according to claim 5 wherein the second layer of polymer film comprises at least one of a polyethylene terephthalate (PET) or a polyethyelene terephthalate glycol modified (PETG).

7. A packaging film according to any one of the preceding claims 1 wherein the first layer of polymer film comprises:
(i) copolyamide PA6I/6T;
(ii) a blend of a copolyamide, such as PA6/66 or PA6I/6T and an amorphous multipolyamide, such as PA66/69/610/6I; or
(iii) a blend of two or more polyamides comprising at least one amorphous polyamide, for example a blend of polyamides selected from the group consisting of PA6 (polycaprolactam), PA66 (Polyhexamethylene adipamide), PA12 (Polydodecanolactam), PA69 (Polyhexamethylene azelaamide), PA610 (hexamethylene sebacamide), PA11 (Poly(11 aminoundecanoamide), PA612 Poly(hexamethylene dodecanoamide), PA6/66, PA6I/6T, and PA66/69/610/6I.

8. A packaging film according to claim 5 wherein the second surface of the first layer of polymer film is adhered to a third layer, the third layer comprising an amorphous polyester

9. A packaging film according to claim 5 wherein the second surface of the first layer of polymer film is adhered to a third layer comprising at least one of polyethylene, an ethylene-vinyl acetate copolymer, an ethylene-methyl acrylate copolymer, or an ethylene-butyl acrylate copolymer.

10. A packaging film according to claim 5 wherein the second surface of the second layer of polymer film is adhered to a third layer, the third layer comprising a semi-crystalline polyamide.

11. A packaging film according to claim 10 wherein the third layer comprises at least one of PA6 and polyamide MXD6.

12. A packaging film according to claim 5 wherein the second surface of the second layer of polymer film is adhered to a third layer, the third layer comprising one or more styrene co-polymers.

13. A packaging film according to claim 1 wherein the second layer of polymer film comprises at least one of an ethylene-vinyl acetate copolymer, an ethylene-methyl acrylate copolymer, and an ethylene-butyl acrylate copolymer.

14. A packaging film according to claim 13 wherein the second layer of polymer film comprises at least 80 wt % of ethylene-vinyl acetate copolymer, ethylene-methyl acrylate copolymer, and/or the ethylene-butyl acrylate copolymer based on the total weight of the components of the second layer of polymer film.

15. A packaging film according to claim 13 wherein the first layer of polymer film comprises:
(i) copolyamide PA6I/6T;
(ii) a blend of a copolyamide, such as PA6/66 or PA6I/6T and an amorphous multipolyamide, such as PA66/69/610/6I; or
(iii) a blend of two or more polyamides comprising at least one polyamide, for example a blend of polyamides selected from the group consisting of PA6 (polycaprolactam), PA66 (Polyhexamethylene adipamide), PA12 (Polydodecanolactam), PA69 (Polyhexamethylene azelaamide), PA610 (hexamethylene sebacamide), PA11 (Poly(11 aminoundecanoamide), PA612 Poly(hexamethylene dodecanoamide), PA6/66, PA6I/6T, and PA66/69/610/6I

16. A packaging film according to claim 13 wherein the second surface of the second polymer layer is adhered to a third layer, the third layer comprising a polyamide.

17. A packaging film according to claim 1 with a thickness of between 10 and 70 μm, preferably between 15 and 60 μm, more preferably between 18 and 40 μm.

18. (canceled)

19. (canceled)

20. (canceled)

21. A fresh produce package comprising a packaging film as defined in claims 1.
